(19) United States
(12) Patent Application Publication
(10) Pub. No.: US 2014/0042144 A1
(43) Pub. Date: Feb. 13, 2014

(54) FILLER WIRE FOR A LASER HOT WIRE SYSTEM

(71) Applicants: Steven R. Peters, Huntsburg, OH (US); Paul E. Denney, Bay Village, OH (US)

(72) Inventors: Steven R. Peters, Huntsburg, OH (US); Paul E. Denney, Bay Village, OH (US)

(73) Assignee: LINCOLN GLOBAL, INC., City of Industry, CA (US)

(21) Appl. No.: 13/572,088

(22) Filed: Aug. 10, 2012

(51) Int. Cl. B23K 35/16

(52) U.S. Cl. 219/145.41; 219/145.1

(57) ABSTRACT

An extruded filler wire for use in a hot wire process. The filler wire includes a first core component; and a second coating component coupled to at least a portion of the first core component, the second coating component having a different composition from the first component, where the wire has a cross-sectional area with the first and second components asymmetrically arranged about a center of the wire.

### TECHNICAL FIELD

The subject invention generally relates to a filler wire for use in a hot wire process used, for example, in overlaying, welding and/or other joining applications. More particularly, certain embodiments relate to an extruded wire with an extruded alloy about a core wire.

### BACKGROUND

In a hot wire or filler wire process, a high intensity energy source, such as for example, a laser, non-consumable tungsten electrode, GMAW arc or plasma is used to heat and melt a workpiece to form a molten puddle. A filler wire is advanced towards a workpiece and the molten puddle. The wire is resistance-heated by a separate energy source such that the wire approaches or reaches its melting point and contacts the molten puddle. The heated wire is fed into the molten puddle for carrying out the hot wire process. Accordingly, transfer of the filler wire to the workpiece occurs by melting the filler wire into the molten puddle. Alternatively, the filler wire may be solid as the wire enters the molten puddle. Because at least some of the filler wire is pre-heated to at or near its melting point, its presence in the molten puddle will not appreciably cool or solidify the puddle and is quickly consumed into the molten puddle.

Consumable filler wires for use in the hot wire process may be solid, flux cored or wire cored. In the case of a flux cored consumable wire, a flux alloy is surrounded by a metallic sheath. In wire cored electrodes a central wire is coated with a flux coating. In each type of wire, the flux alloy includes metallic components that may become part of the weld bead formed by the hot wire process. However, for known hot wire processes, a majority of the metal contributed by the consumable wire is from either the metallic sheath or the metal wire core. Consumable wires are generally circular in which the wire or flux core are centered to define a symmetrical cross-sectional of the consumable filler wire. The use of known wire configurations in laser/hot-wire applications can lead to superheating of the top of the wire and/or some of its powder components, which can lead to undesirable expelling of some of the powder away from the puddle.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention comprise a consumable having a first portion with a first cross-section with a first geometric center, and a second portion adhered to the first portion such that the first portion and the second portion form the consumable having a consumable cross-section with a consumable geometric center, wherein the consumable cross-section is asymmetrical such that the first geometric center is offset from the consumable geometric center.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a functional schematic block diagram of an exemplary embodiment of a hot wire system;

FIG. 1A is a perspective detailed view of a hot wire process using the system of FIG. 1;

FIG. 2 is a cross-sectional view of an exemplary extruded filler wire for use in the hot wire process of FIG. 1;

FIGS. 3A-8 are cross-sectional views of various embodiments of filler wire for use in the hot wire process of FIG. 1; and

FIG. 9 is a cross-sectional view of a further exemplary embodiment of the present invention.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

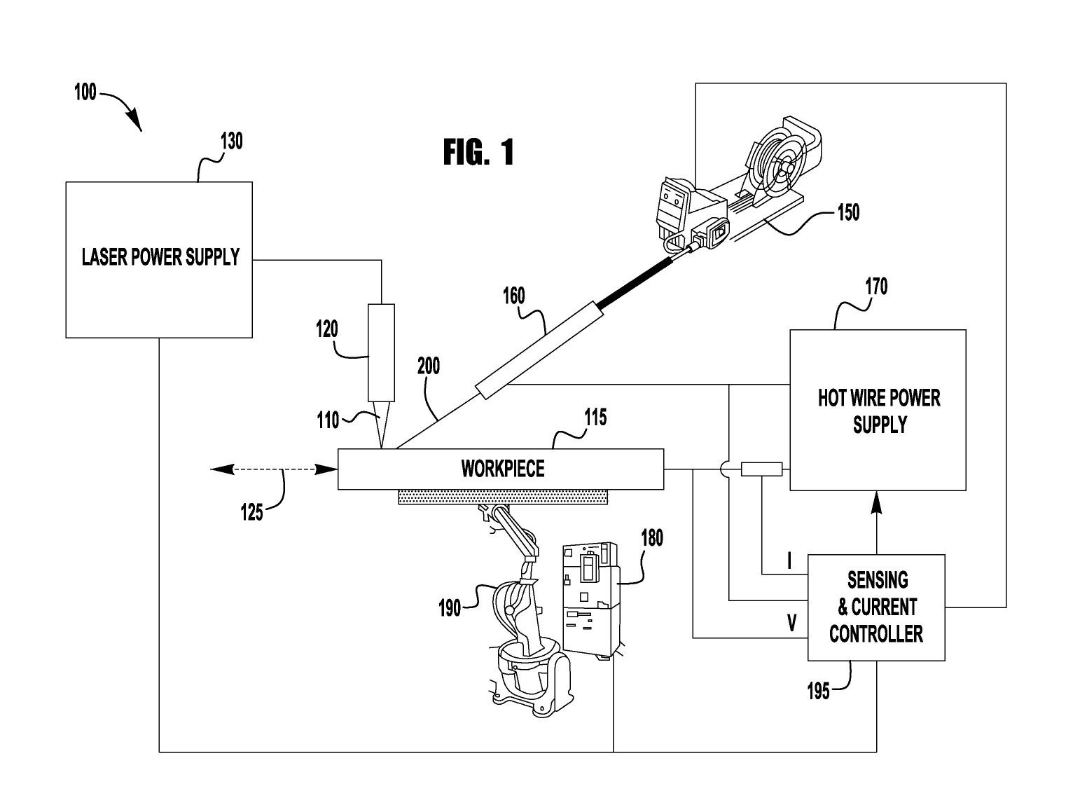

FIG. 1 illustrates a functional schematic block diagram of an exemplary embodiment of a system 100 for performing a hot wire process. The term “hot wire process” is used herein in a broad manner and may refer to any applications including overlaying, welding or joining. More particularly, a hot wire process includes heating a filler wire (for example using resistance heating) to perform an overlaying, welding, brazing and/or other joining process. Overlaying processes may include: brazing, cladding, building up, filling, and hard-facing. Additional processes can include the production of structural components, such as through laser additive manufacturing. For example, in a “brazing” application, a filler metal is distributed between closely fitting surfaces of a joint via capillary action. Whereas, in a “braze welding” application of the filler metal is made to flow into a gap. As used herein, however, both techniques are broadly referred to as overlaying applications. The system 100 includes a hot filler wire feeder subsystem capable of providing at least one heated filler wire 200 to make contact with the workpiece 115. Of course, it is understood that by reference to the workpiece 115 herein, a molten puddle 116 formed in the workpiece is considered part of the workpiece 115, thus reference to contact with the workpiece 115 includes contact with the puddle to the extent any puddle is present.

The hot filler wire feeder subsystem includes a filler wire feeder 150, a contact tube 160, and a hot wire power supply 170. The wire 200 is fed from the filler wire feeder 150 through the contact tube 160 toward the workpiece 115 and extends beyond the tube 160. The hot wire power supply 170 may be a constant or pulsed direct current (DC) power supply, although alternating current (AC) or other types of power supplies are possible as well. Accordingly, the power supply 170 may be operated to apply any one of a voltage or current signal to the wire 200. Although the power supply 170 may include a single power source or more than one power source to apply the various currents or establish the various voltages described in greater detail below.

In one aspect of the power supply 170 can apply a sensing signal to the wire 200 to determine the proximity of the wire to the workpiece. In another aspect, the power supply applies a current to the wire which can establish an arc between the wire and the workpiece. In yet another aspect, the filler wire 200 is resistance-heated by electrical current from the hot wire power supply 170 which is operatively connected between the contact tube 160 and the workpiece 115.

The exemplary system 100 further includes a control subsystem 195 which is capable of measuring a potential difference (i.e., a voltage V) between, and a current (I) through, the workpiece 115 and the hot wire 200. In at least one exemplary embodiment, the control subsystem 195, which may be embodied as a state based current sensing controller, is operatively connected to the workpiece 115, the contact tube 160 and the hot wire power supply 170, so as to regulate functions of the power supply such as for example, output current, voltage and/or power. The control subsystem 195 may include secondary or parallel controllers to regulate or monitor other aspects of the system and or hot wire process, such as for example, laser power, wire feed rates and/or puddle shape or temperature.

The system 100 further includes a laser subsystem capable of focusing a laser beam 110 onto a workpiece 115 to heat the workpiece 115 in order to, for example, maintain the molten puddle at the workpiece. The laser subsystem includes a laser device 120 and a laser power supply 130 operatively connected to each other. The laser power supply 130 provides power to operate the laser device 120. Functions of the laser power supply 130 which may include, for example, output of current, voltage or power in real time individually or for synchronized operation with the hot wire power supply 170. The laser subsystem can be any type of high energy laser source, including but not limited to carbon dioxide, Nd:YAG, Yb-disk, YB-fiber, fiber delivered or direct diode laser systems. The laser subsystem is also more generally a high intensity energy source providing, for example, at least 500 W/cm². Other high energy heat source can also be used and embodiments of the present invention are not limited to the use of a laser system.

For some applications (such as welding), the laser beam 110 is sufficiently intense in its energy to melt some of the base metal of the workpiece 115 and/or melt the wire 200 onto the workpiece 115. Accordingly, the power supply 170 is configured to provide a large portion of the energy needed to resistance-melt the filler wire 200 for carrying out the hot wire process. In addition, the power supply 170 and the feeder subsystem are configured to terminate the hotwire process to provide for separation of the wire from the molten puddle.

The system 100 further includes a motion control subsystem capable of moving the laser beam 110 (energy source) and the resistive filler wire 200 in a same direction 125 along the workpiece 115 (at least in a relative sense) such that the laser beam 110 and the resistive filler wire 200 remain in a fixed relation to each other. The relative motion between the workpiece 115 and the laser/wire combination may be achieved by moving the workpiece 115 or by moving the laser device 120 and the hot wire feeder subsystem. For example, as seen in FIG. 1, the motion control subsystem includes a motion controller 180 operatively connected to a robot 190. The motion controller 180 controls the motion of the robot 190. The robot 190 is operatively connected (e.g., mechanically secured) to the workpiece 115 to move the workpiece 115 in the direction 125 such that the laser beam 110 and the wire 140 effectively travel along the workpiece 115. In accordance with an embodiment of the present invention, the motion controller 180 may further be operatively connected to the laser power supply 130 and/or the sensing and current controller 195. In this manner, the motion controller 180 and the laser power supply 130 may communicate with each other to coordinate activities between the various subsystems of the system 100. Further discussion of the system 100 and its operation is found in US Publication No. 2011/0297658, the disclosure of which is incorporated herein by reference in its entirety.

Shown in FIG. 1A is a detailed view of a hot wire process at the site of a molten puddle 116 on a workpiece 115. More specifically shown is a laser beam 110 maintaining the molten puddle 116 striking the heated filler wire 200 with the distal end of the wire located and advanced into the molten puddle 116. Generally, one embodiment of method of a hot wire process provides for bringing the filler wire 200 into proximity of the workpiece 115 and striking an upper portion of the wire 200 with the laser beam and more particularly striking the wire core component of the filler wire 200. The laser heats the filler wire 200 to allow the flux component of the wire to be advanced into the molten puddle to complete the hot wire process. Accordingly in one particular aspect of the subject process, transfer of the wire material to the puddle 116 occurs by melting of the wire 200 directly into the molten puddle. This will be discussed more fully below.

Shown in FIG. 1A is an exemplary filler wire component 200 having a first portion 205 that is heated by laser beam 110 and/or power supply 170 for deposition into a molten puddle 116. (It should be noted that the first portion 205 is also referred to herein as the “core component”). Shown in FIG. 1A is a perspective cross-sectional view of an exemplary embodiment of a filler wire 200 subject to the hot wire process. The wire 200 defines a wire longitudinal axis X-X and includes a first portion 205 and a second portion 210 (also referred to herein as “coating” or “coating component”). In one exemplary embodiment, the second portion 210 is an external coating to the first portion 205. For the embodiment shown, the cross-sectional geometry of the wire 200 is substantially circular to define a wire diameter D and a wire center C disposed along the wire axis X-X. The filler wire 200 may define alternative geometries, for example, as described in greater detail below.

In exemplary embodiments of the present invention, the core component 205 is a conductive member made of a metallic material such as a welding steel, for example, ordinary low-carbon steel or a nickel (Ni) alloy, which is conductive of electricity. In these embodiments, the components 205 can be heated by the power supply 170 using resistance heating to aid in the melting of the consumable 200. In addition to providing the base, substrate or core about which the coating component 210 may adhere, the core component 205 can be configured to angularly orient the wire 200 to the laser beam 110 to facilitate the hot wire process. More specifically, the core component 205 can be used by a hot wire operator to locate the core component 205 in the path of the laser beam to shield the second wire component 210 from the heat of the laser beam of the hot wire process. In exemplary embodiments, the component 205 is oriented such that it is impinged by the beam 110 during the welding/overlaying operation. This is shown in at least FIG. 1A. Of course, other embodiments are not limited to this orientation.

By using exemplary embodiments of the consumables described herein, at least some of the flux or component 210 is shielded from a laser beam 110 or heat source. This shielding aids in allowing at least some of the component 210 to be deposited into the puddle without being changed or adversely affected by the heat used to create the puddle or melt the component 205. In some traditional consumable constructions, an appreciable portion of the flux can be burned off or otherwise adversely affected by the heat prior to entering the puddle. Embodiments of the present invention use the component 205 to shield at least some of the component 210 so that the component 210 can be added to the puddle in a controlled and predictable state.

In some exemplary embodiments of the present invention, the coating is a non-conductive coating such that only the component 205 is conductive. This can help with controlling the heating current to aid in preventing the creation of an arc. Alternatively, the component 210 is conductive but has a different conductivity than the portion 205, such that the coating 210 can also be heated and/or melted through the use of a heating current, which can aid in the component 210 being consumed in the molten puddle 116. The coating 210 can be secured to the component 205 via known methods of securing fluxes (and similar materials) to substrates or cores. Accordingly, an embodiment of the coating 210 provides for a matrix that includes special alloys to make up the hot wire bead upon cooling of the molten puddle 116. In one formation of the filler wire 200, the coating 210 may be extruded over the core 205 and more particularly may be a conductive carbide alloy, such as for example, tungsten alloy carbide.

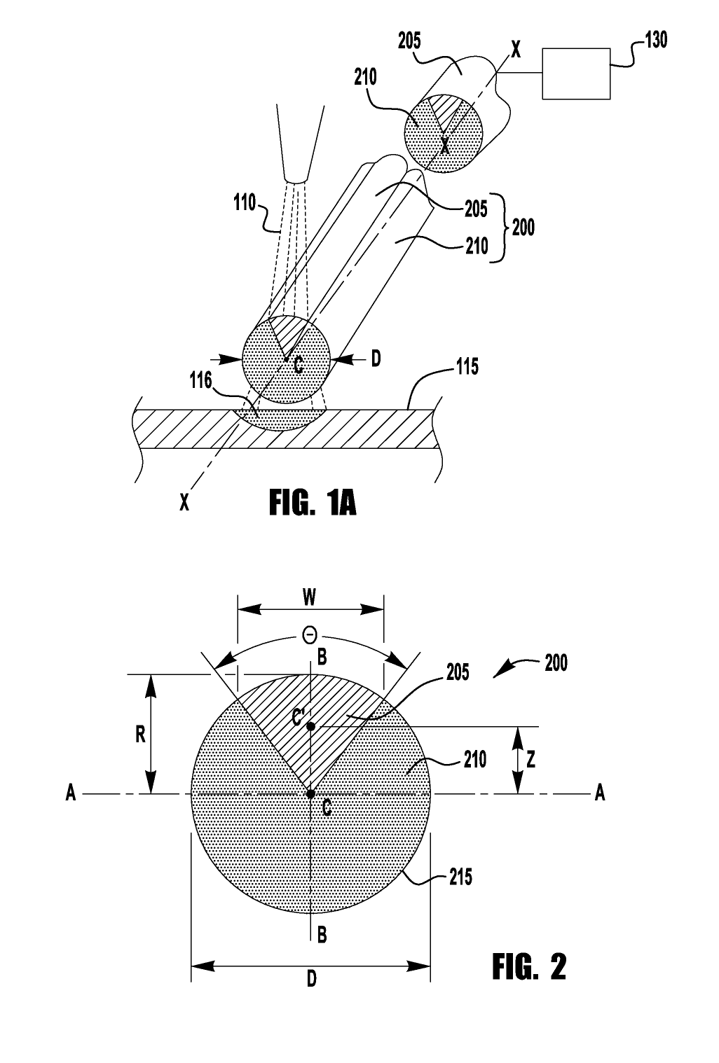

Shown in FIG. 2 is a cross-sectional end view of the exemplary filler wire 200 defining a first axis A-A and a second axis B-B perpendicular to the first axis A-A. In one aspect, the core component 205 defines a first cross-section, such as for example a wedge or triangle which extends radially a distance R from the wire center C. In one exemplary embodiment, the core component 205 extends radially to the peripheral surface 215 of the electrode wire 200. When formed as a wedge, the core component 205 can further span a radial angle θ about the filler wire center C. As shown, the core component 205 may define a first core width W. In some exemplary embodiments, the core width W is constant along the length of the consumable 200. However, in other exemplary embodiments the width W may vary along the length. Accordingly, the core component 205 and coating 210 are arranged such that the cross-sectional distribution of the filler wire 200 is asymmetrical, for example about one or both of the first axis A-A and second axis B-B. That is, as shown the core component 205 has a geometric center C′ which is offset from the geometric center of the wire 200 by a distance Z. In a typical wire, which has a core and a sheath the geometric center of those components overlap because the wire is symmetrical. However, because of the asymmetrical nature of the cross-section of embodiments of the present invention, the geometric center C′ of the core component 205 is offset from the geometric center C′ of the wire 200, relative to at least one of the axes A-A/B-B. Accordingly, the core component 205 can be used to orient the wire 200 to the laser beam 110 in the course of the wire feed and hot wire process. For example, the portion 205 can be used to visually allow for the alignment of the consumable 200, or the wire feeding system can have physical components which utilize the portion 205 to align the consumable 200 within the tube 160 so that the orientation is in the desired position. Of course, in some embodiments, as shown in FIG. 2, the overall cross-sectional shape of the wire 200 is symmetrical, but the distribution between the portions 205 and 210 is asymmetrical. Additionally, in other exemplary embodiments, the overall cross-sectional shape of the wire 200 can be asymmetrical, as shown and discussed below in further detail.

As an external coating, the outer component 210 in one aspect defines the maximum diameter D. For one particular embodiment of the filler wire 200, the maximum diameter is consistent with known welding consumable diameters, including but not limited to 0.030″, 0.045″, 0.052″, 0.062″, etc. Alternative nominal wire diameters may be provided so long as the outer component 210 and core component 205 can be configured for use in a hot wire process as described. For the embodiment shown in FIG. 2, the coating component 210 is extruded about the wedge shaped core component 205 to define the substantially circular cross-section. Accordingly, each component 205, 210 define a percentage of the filler wire cross-sectional area. In one embodiment, the cross-sectional areas of the components define a second component 210 to first component 205 ratio of areas which range from ½:1 to 10:1, may be 1:1 and in one particular embodiment is at least about 2:1. The ratios can be affected by the sizes of at least some of the particles used in the coating 210. That is, when larger particles are used (larger than 100 microns) the ratio in some embodiments will be in the range of 1:1 to 4:1. However, when smaller particles are used (less than a 100 microns) the maximum ration can be higher and can be as high as 10:1. In a further aspect, exemplary embodiments of the present invention provide for filler wire 200 with the coating component 210 defining 30 to 75% of the wire cross-sectional area. In some exemplary embodiments, the coating represents at least 50% of the wire 200 cross-sectional area. Of course, the exact percentage of the coating 210 will vary depending upon the amounts of the coating 210 and component 205, respectively, are needed for the desired weld deposit.

In further exemplary embodiments, the width W of the exposed portion of the component 205 is in the range of 25 to 100% of the maximum width D of the wire 200. This aids in protecting the component 210 below the component 205 when being irradiated by the laser beam 110. In further exemplary embodiments, as depicted in FIGS. 1A and 2, the angle θ is in the range of 45 to 180 degrees. Of course, other dimensions can be used based on the desired weld deposition composition, and other attributes of the operation. In exemplary embodiments of the present invention, the size and shape of the wire utilized can be a function of the size/power of the laser beam used, the wire feed rates used and/or desired ratios of the first component 205 to the coating 210.

The core and coating components 205, 210 may define alternative configurations to provide for a filler wire that can be effectively used in a hot wire process described. That is, embodiments of the present invention can use many different shapes and configurations consistent with the scope and spirit of the invention described herein, and are not limited to circular cross-sections. Of course, circular cross-sections can utilize existing wire feeding devices and systems, but these systems can also be used for feeding of wire 200 having different cross-sections as contemplated herein.

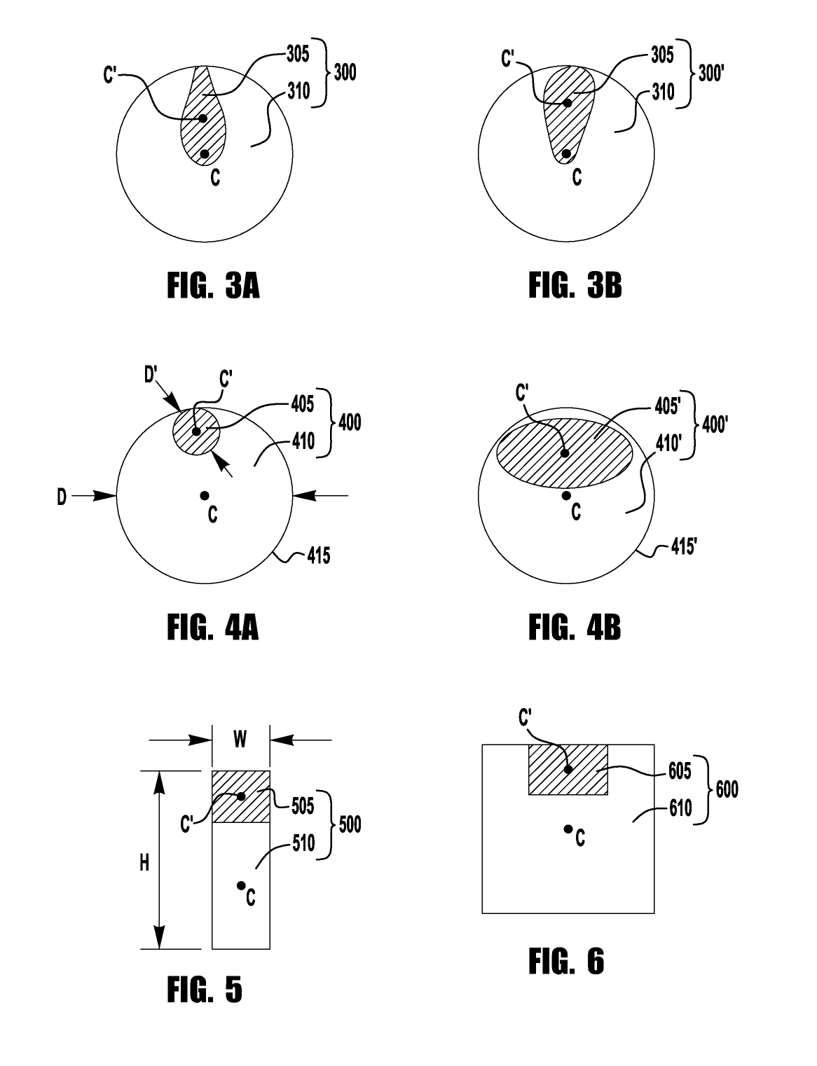

Shown in FIGS. 3A-8 are alternate embodiments of a filler wire configuration. The alternative embodiments of filler wire, in one aspect, provide exemplary area or weight ratios of the core and coating components to effect a hot wire process Shown in FIGS. 3A and 3B, is a filler wire 300, 300′ in which the core component 305 is teardrop shaped with the coating component extruded about the core component 305 to define a substantially circular cross-section of the filler wire 300, 300′. The teardrop core component 305 may narrow in the radial direction to the peripheral surface of the filler wire 300 as seen in FIG. 3A. Alternatively, the core component 305 may narrow from the peripheral surface to the center of the wire C as seen in FIG. 3B. The core component 305 may be oriented so as to facilitate extrusion of the outer coating component 310 about the core component 305.

FIG. 4A shows another embodiment of a filler wire 400 having a circular cross-section. The exemplary embodiment shows a circular core wire 405, in which the coating component 410 is extruded such that the core component 405 is eccentrically located relative to the center wire C. In one aspect, the circular core component is tangential to or exposed at the peripheral surface 415. Moreover, in another aspect, the filler wire defines a maximum diameter D which is in the range of 1.25 to 5 times the diameter D′ of the core component 405. In an alternate embodiment 400′, the core component 405′ is oblong, elliptical or oval in cross-section, as shown in FIG. 4B. In the embodiment shown in FIG. 4B, the core component 405′ is not exposed at the peripheral surface 415′ but is instead eccentrically located relative to the center C of the filler wire 400′ such that the wire can be rotationally oriented. Accordingly, the core component may be completely coated and define a minimum thickness of the second coating component 410′. In other exemplary embodiments of the present invention, the overall cross-sectional shape of the wire 200/300/400 can be elliptical, oval or oblong, and not circular as shown. This shape can also aid in the orientation of the wire during the operation. In some exemplary embodiments in which the component 410′ covers the component 405′, or at least minimizes the exposed surface of the portion 405′, and the wire 400′ is to be heated via resistance heating, the portion 410′ should be made of an electrically conductive material such that the portion 410′ allows for the transfer of current to allow facilitate the resistance heating operation.

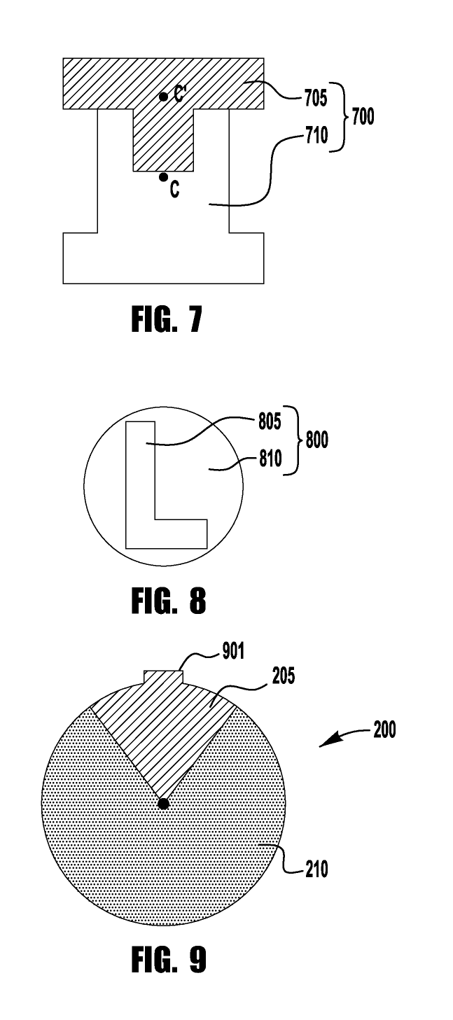

FIGS. 5, 6, and 7 provide alternate embodiments of a filler wire defining non-circular cross-sections, having a generally polygonal shape. Shown in FIG. 5, the filler wire 500 is rectangular in cross-section having a width W and a height H, where the width W is less than the height H. In this embodiment, the width W of the portion 505 is the maximum width of the wire 500 so that the portion 510 can be completely shielded from the laser 110 during the operation. In exemplary embodiments of the present invention, the height H is 1.25 to 5 times the width W, while in other embodiments the height H is 2 to 4.5 times. It should be noted that if the height H of the wire 500 becomes too large it can be difficult to easily deliver the entirety of the wire 500 to a puddle in a controlled fashion. With tall wires the delivery of the wire to the puddle will need to have a near vertical orientation. In the embodiment shown, the core component 505 is substantially square in cross-section. Shown in FIG. 6 is another filler wire 600 embodiment also defining a rectangular cross-sectional and more particularly a square cross-sectional area—which can also have other polygonal type shapes. In the embodiment shown, the component 605 is square in cross-section surrounded—on three sides—by the conductive alloy component 610, such that the impact surface width of the portion 605 is less than impact surface width of the overall consumable 600. Shown in FIG. 7 is an embodiment of the filler wire 700 defining a substantially I-shaped cross-section. The component 705 in one aspect is T-shaped to provide a base to form sufficient surface about which the second component 710 is extruded about the component 705. Thus, as shown, embodiments of the present invention can take on any number of different shapes without departing from the spirit or scope of the present invention.

In another embodiment shown in FIG. 8, the core component can be letter or symbol shaped so as to provide additional indicia in addition orienting the filler wire 800 for the hot wire process. Additionally, the letter/symbol can identify some attribute of the wire, including but not limited to its composition. That is, the portion 805 can have a shape that provides identification of an attribute of the consumable 800. As shown in this figure, the overall shape of the wire 800 is circular in cross-section, however, other embodiments can use different cross-sectional shapes. Of course, in embodiments, the shape and/or orientation of the wire 800 during operation provides the necessary protection from the laser/heat source of the component 810 as described herein.

FIG. 9 depicts another exemplary embodiment of the present invention having a similar construction to that shown in FIG. 2, except that the surface of the consumable 200 has at least one protrusion 901 extending from its surface. The protrusion 901 is used to aid in orienting the consumable during its delivery to the weld puddle. For example, the tube 160 can have a slot which corresponds to the protrusion 901 so that the orientation of the wire 200 is maintained as desired. In some embodiments, the protrusion 901 can extend along the length of the entire wire 200, while in others it can be intermittent. Further, in the embodiment shown the protrusion 901 extends from the portion 205, but, in other embodiments the protrusion can extend from the portion 210. However, in the embodiments with the protrusion 901 extending from the portion 205 the protrusion 901 will generally be stronger as the portion 205 is the metal substrate, as opposed to the flux/matrix portion 210.

FIG. 1 and the above description of system 100 provide for a general component description of a system for carrying any one of the subject start and/or stop methods to a hot wire process. Described in U.S. Patent Application Publication No. 2011/0297658, U.S. Patent Application Publication No. 2010/0176109, each of which is incorporated by reference in its entirety, are alternative or additional embodiments of the system 100 for carrying out the subject start and/or stop methods and an associated hot wire process.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

We claim:

1. A hot-wire consumable, comprising:
a first portion having a first cross-section with a first geometric center; and
a second portion adhered to said first portion such that said first portion and said second portion form said hot-wire consumable having a consumable cross-section with a consumable geometric center;
wherein said consumable cross-section is asymmetrical such that said first geometric center is offset from said consumable geometric center.

2. The hot-wire consumable of claim 1, wherein said consumable cross-section is non-circular.

3. The hot-wire consumable of claim 1, wherein said second portion is not conductive.

4. The hot-wire consumable of claim 1, wherein said first portion has a first cross-sectional area and said second portion has a second cross-sectional area, and a ratio between said second cross-sectional area and said first cross-sectional area is in the range of ½:1 to 10:1.

5. The hot-wire consumable of claim 1, wherein said first cross-section is non-circular.

6. The hot-wire consumable of claim 1, wherein a cross-sectional area of said second portion is in the range of 30 to 75% of a total cross-sectional area of said hot-wire consumable.

7. The hot-wire consumable of claim 1, wherein said first portion has an exposed portion along an outer perimeter of said hot-wire consumable, where said exposed portion has a maximum width, and said exposed maximum width is in the range of 25 to 100% of the maximum width of the consumable.

8. The hot-wire consumable of claim 1, wherein said first cross-section has a different shape than said consumable cross-section.

9. The hot-wire consumable of claim 1, wherein said first portion has a projection from a surface of said first portion to align said consumable.

10. The hot-wire consumable of claim 1, wherein an axis passes through each of said first geometric center and said consumable geometric center and said consumable is not symmetrical relative to said axis.

11. A hot-wire consumable, comprising:
a first portion which is a solid metallic component having a first cross-section with a first geometric center; and
a second portion comprising a plurality of granular particles adhered to said first portion such that said first portion and said second portion form said hot-wire consumable having a consumable cross-section with a consumable geometric center;
wherein said consumable cross-section is asymmetrical such that said first geometric center is offset from said consumable geometric center.

12. The hot-wire consumable of claim 11, wherein said consumable cross-section is non-circular.

13. The hot-wire consumable of claim 11, wherein said second portion is not conductive.

14. The hot-wire consumable of claim 11, wherein said first portion has a first cross-sectional area and said second portion has a second cross-sectional area, and a ratio between said second cross-sectional area and said first cross-sectional area is in the range of ½:1 to 10:1.

15. The hot-wire consumable of claim 11, wherein said first cross-section is non-circular.

16. The hot-wire consumable of claim 11, wherein a cross-sectional area of said second portion is in the range of 30 to 75% of a total cross-sectional area of said hot-wire consumable.

17. The hot-wire consumable of claim 11, wherein said first portion has an exposed portion along an outer perimeter of said hot-wire consumable, where said exposed portion has a maximum width, and said exposed maximum width is in the range of 25 to 100% of the maximum width of the consumable.

18. The hot-wire consumable of claim 11, wherein said first cross-section has a different shape than said consumable cross-section.

19. The hot-wire consumable of claim 11, wherein said first portion has a projection from a surface of said first portion to align said consumable.

20. The hot-wire consumable of claim 11, wherein an axis passes through each of said first geometric center and said consumable geometric center and said consumable is not symmetrical relative to said axis.
